(19) United States
(12) Patent Application Publication
(10) Pub. No.: US 2002/0083421 A1
(43) Pub. Date: Jun. 27, 2002

(54) Assembly language code compilation for an instruction-set architecture containing new instructions using the prior assembler

(75) Inventor: John Simons, San Mateo, CA (US)

Correspondence Address: Robert J. Bennett, TOWNSEND and TOWNSEND and CREW LLP, 8th floor, Two Embarcadero Center, San Francisco, CA, 94111-3834, US

(73) Assignee: Hitachi America, Ltd.

(21) Appl. No.: 09/747,824

(22) Filed: Dec. 22, 2000

(51) Int. Cl. G06F 9/45

(52) U.S. Cl. 717/140

(57) ABSTRACT

A assembler extended instruction set architecture ISA is formed from a current ISA to which is added new instructions. Assembly of source code listing of a mixture of current and new assembly language instructions is accomplished by preprocessing the source code to create a temporary file that contains the old instructions and data directives for each of the new assembly instructions that have, as the data arguments, the object code equivalent of such new instruction. The temporary file is then applied to the old assembler to produce, for each of the old assembly language instructions, the corresponding object code. The result, after linking, is an executable, machine language program for the new ISA.

### BACKGROUND OF THE INVENTION

The present invention relates generally to compilation of assembly language source code to object code, and more particularly to compilation of source code having new assembly-language instructions, using an old assembler.

As microcomputers and microprocessors (hereinafter, “processors”) are developed and their designs upgraded and/or enhanced, so to are the assembly language instruction-set architectures (ISAs) used for the processors. Instructions may be added to the ISA of the processor to take advantage of previously unseen features, or to add performance features to the processor.

FIG. 1 diagrammatically illustrates assembly of source code to produce the machine-readable object code that can by executed by a processor 12, or run on an instruction-set simulator (ISS) 14. As FIG. 1 shows, a source code file (File.asm) 20 containing source code assembly language instructions is applied to an assembler (asm) 22, running on a computing unit (not shown). The assembler 22 operates to convert each of the assembly language instructions contained in File.asm to machine language translations (object code) that are written to an object file (File.obj) 24. The object file is then applied to a linker (Ink) 28 to merge object code modules, resolve references, etc. as is conventional, to produce a unitary program executable by the processor 12 or the ISS 14. The linked result is written by the linker 28 to an executable file (File .exe) 30.

However, the design of ISAs, or their corresponding processors, are not frozen in stone. As is often the practice, a next-generation processor is designed with features of its predecessor. This, in turn, is accompanied by a redesign of the ISA to include additional assembly language instructions that will take advantage of those features added to the next-generation processor, but keeping many if not all of the assembly language instructions of the prior ISA. In some cases instructions may be added to an ISA without a concomitant change of the processor to take advantage of features not fully appreciated before.

Of course, these developmental changes in the processor 12 of FIG. 1, or in the current ISA, or both, will result in a new or extended ISA. While the current assembler remains available to assemble the old instructions included in the new ISA, it will be incapable of handling the new, added instructions. Thus, a new assembler is required to interpret and convert (to object code) the added instructions as well as the older instructions. Now, as FIG. 2 illustrates, a source code file 20′, containing both old assembly language instructions 20a and new instructions 20b, requires a newly-developed assembler 22′ to produce machine language object code for both the new and old instructions 20a, 20b. As before, the object code produced by the new assembler is written to file 28 to produce, when linked by linker 28, executable code executable by the new processor 12′ and/or the new ISS 14′.

Unfortunately, this development effort usually has different groups of designers working on different aspects of the design. That is, development of the new simulator tool (ISS 14′) for the new ISA is often the responsibility of the team that is also responsible for developing the new ISA. But, development of the new assembler may be responsibility of a different team—often in a different geographic location, or worse, a different (third party) organization. This means that testing and debugging of the new ISA, or even the new ISS, must await completion of the new assembler. This makes it difficult for the assembler program to change quickly, much less allow it to change over a period of time as the extended ISA evolves. The developers of the extended ISA and new ISS must wait until the design and development of the new assembler is finished before using it to debug the extended ISA by compiling test programs, which may, in turn, necessitate changes in the assembler, and so on. This is a reiterative procedure that makes the overall task of changing processor/ISA designs a lengthy process. The current or old assembler is of no use in this development effort because it is incapable of properly interpreting and converting the new instructions.

Existing methods attempt to accelerate the development of the new assembler to support the new instructions, but this does not do away with the reiterative process described above.

Thus, it can be seen that there is a need for a technique to be able to assemble code for a new ISA containing new instructions so that the development of an extended ISA can continue concomitant with the development of the new assembler and software assets upgraded to the new ISA before the product assembler is developed.

### SUMMARY OF THE INVENTION

The present invention provides a simple and effective method of assembling instructions of a new assembly language instruction set architecture using the old assembler to produce a machine language program executable by the new instruction-set simulator, or a new processor, if available.

Broadly, the invention is a method of using the old assembler to assemble source code containing both old and new assembly instructions of a new ISA to produce corresponding object code. According to an embodiment of the invention, the source code is first examined by a preprocessor that writes each old instruction to a temporary file unchanged. When a new instruction is encountered in the source code, it is written to the temporary source file as inserted data representing the object code equivalent of the new instruction. The temporary source file is then applied to the old assembler, which converts the old instructions to their corresponding object code, but passes over the inserted data, leaving the inserted data representing object code for the new instructions. The result is then linked using the existing (old) linker, producing a machine language program that can be executed by the new ISS or the new processor.

It will be apparent to those skilled in this art that the method of the present invention provides a number of advantages. First is that the design team in charge of the development of the new ISA need not wait until the new assembler is provided to test the new instructions of the new ISA. When the new assembler is finally available, the new ISA can be ready as a solid benchmark tool for the new assembler.

These and other advantages and aspects of the invention disclosed herein will become apparent to those in this art upon a reading of the following description of the specific embodiments of the invention, which should be taken in conjunction with the accompanying drawings.

### BRIEF DESCRIPTION OF THE DRAWINGS

FIG. 1 is a diagrammatic illustration of the prior art process used to convert an assembly language listing to an executable machine language program;

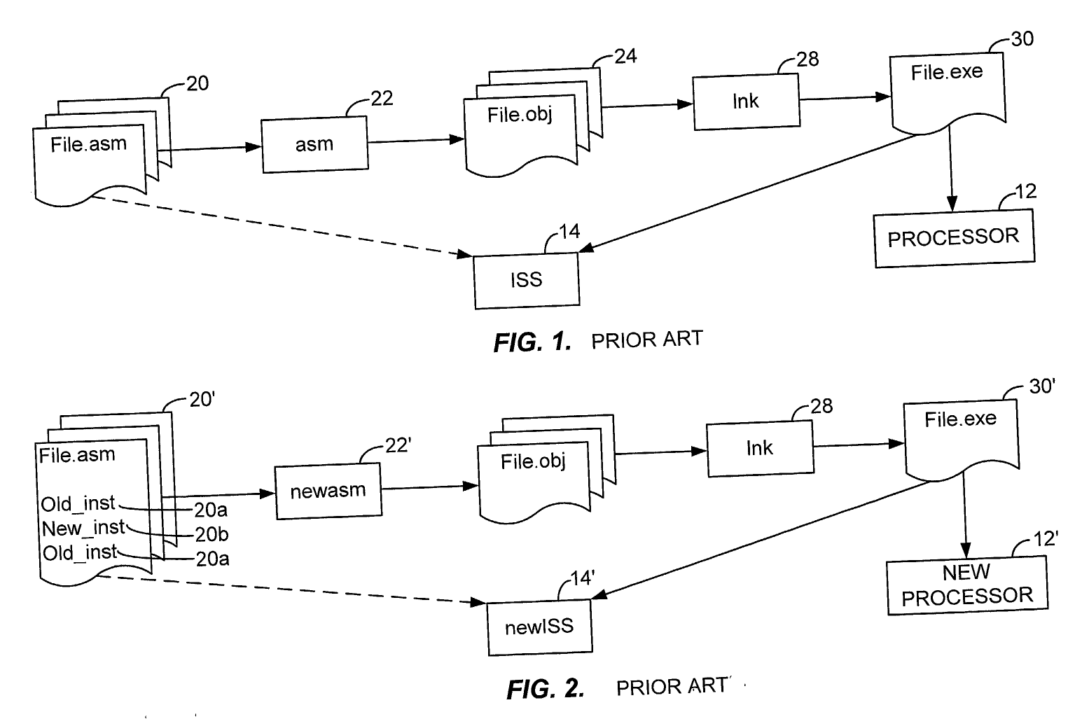

FIG. 2 is a diagrammatic illustration of the prior art process used to convert an assembly language containing both old and new assembly language instructions of a new ISA to an executable machine language program;

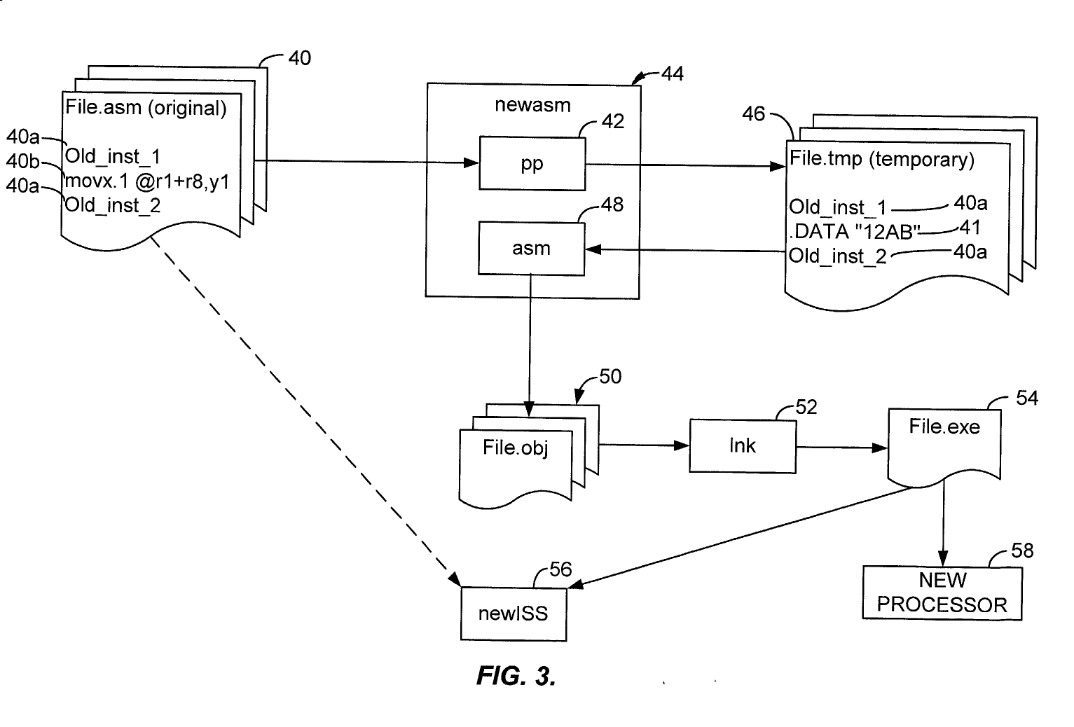

FIG. 3 is a diagrammatic illustration of the present invention to convert an assembly language containing both old and new assembly language instructions of a new ISA to an executable machine language program using the current (old) assembler;

FIGS. 4A and 4B are flow diagrams that illustrate the steps taken according to the present invention to convert an assembly language program, containing both old and new assembly language instructions of a new ISA to object code using the old assembler.

### DESCRIPTION OF THE SPECIFIC EMBODIMENTS

The present invention, as noted above, is a technique for employing an older assembler to produce executable object code from a source code containing old assembly language instructions, compatible with the older assembler, and added, new assembly language instructions not capable of being interpreted by the older assembler. The invention uses the data directive feature usually found presently available in assembler applications. Such data directive features are capable of taking an argument, usually in hexadecimal format, and inserting that argument in the object code unchanged.

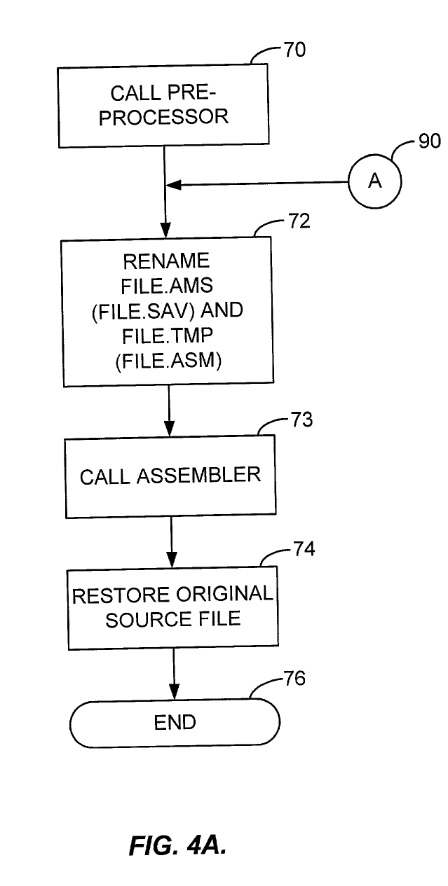

Turning now to the figures, and for the moment FIG. 3, there is illustrated a diagrammatic representation of the method of the present invention as implemented on a processing system (not shown). As FIG. 3 shows, an original source file (File.asm) 40 contains old assembly instructions 40a (Old_inst_1 and Old_instr_2) and new assembly instructions 40b (movx.I @r1+r8, y1) that form a part of a new ISA. The original source file 40 is applied to a preprocessor (pp) software application 42. The preprocessor 42 operates to scan the source file 40, create a temporary source file 46, and write to the temporary source file 46, unchanged, the old assembly instructions 40a, 40b.

Each new instruction 40b encountered by the preprocessor 42 is checked for validity and, if found to be a valid instruction, converted to its object code equivalent. That object code equivalent is then also written to the temporary source code file 46 as the argument of a data directive 41, which usually takes the form of “.DATA [data]”. Thus, as FIG. 3 illustrates, the new instruction 40b, “movx.I @rl+r8, yl”, is converted to its object code equivalent, “12AB” (Hex), and inserted in the temporary source code file 46 as the argument of the data directive statement 41. Each data directive statement 41 will be placed in the instruction sequence of the temporary source code file 46 at the same location (relative to the other instructions 40) corresponding new instruction 40b appeared in the original source code file 40.

The temporary source code file 46, containing now the old assembly language instructions 40a (unchanged) and, for each new assembly language instruction 40b, a corresponding data directive 41, is then assembled in conventional fashion, using the old assembler application program 48, and written to an object file (File.obj) 50.

Although the old assembler is capable of converting the old instructions 40a directly to their object code equivalents, it would have been incapable of handling the new instructions 40b. However, when the old assembler 48 encounters a data directive in the source file, such as the data directive 41, it will use the argument of the data directive, as indicated, the object code equivalent of the new instruction 40b, and insert that object code equivalent in the object file 50. What appears now in the object file 50 are the machine readable object code equivalents of both the old instructions 40a of the original source code 40 and, added as data by the data directives they were converted to, the object code equivalents of the new instructions 40a.

The object file 50 may then be linked, using the old linker 52, to create an executable file (File. exe) 54 that may be run on a newly-developed instruction-set simulator 56 or, if available, the new processor 58 developed for the new ISA.

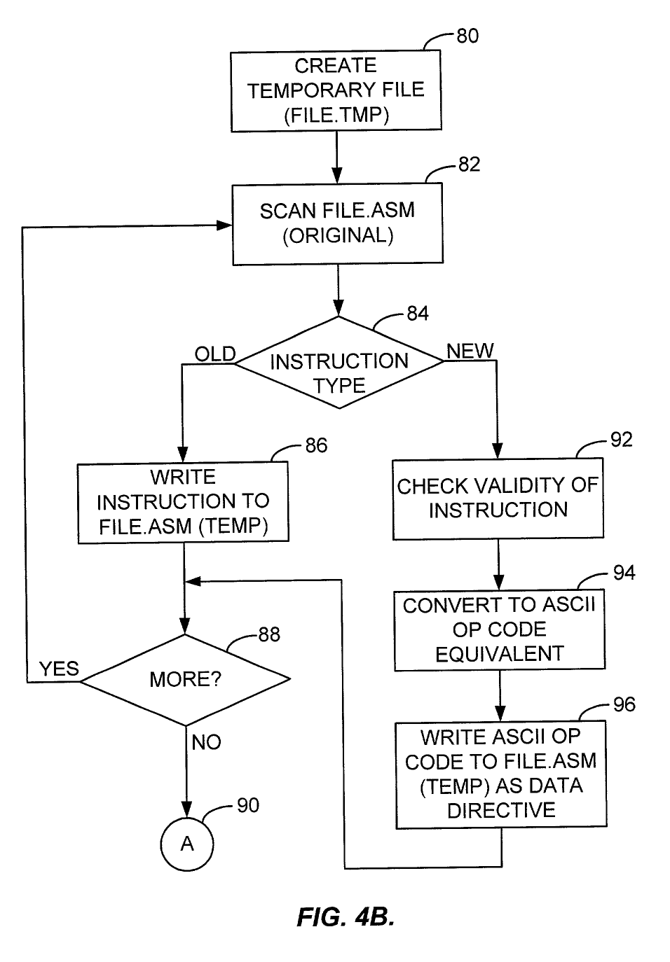

Turning now to FIGS. 4A and 4B, the steps taken to assemble an assembly language program containing new and old instructions according to the invention is illustrated. FIG. 4A broadly shows the steps taken by the control script 44, while FIG. 4B shows the principal steps taken by the preprocessor 42.

Turning first to FIG. 4A, when the control script 44 is invoked, it will first call the preprocessor 42 in step 70, passing to it two arguments: the identification of the source code file 40, and the name of the temporary output file (File.tmp) to be created. Control is then passed to the preprocessor 42, the main operative steps of which are outlined in FIG. 4B.

Turning then to FIG. 4B, it will be seen that the preprocessor 42 will first, in step 80, create the temporary file 46, giving it the temporary filename File.tmp. Next, in step 82, the preprocess 42 will scan the original source code file 40, instruction by instruction. For each instruction, in step 84, the preprocessor 42 will determine if the instruction is an old instruction 40a or a new instruction 40b. If it is an old instruction 40a, step 84 will be left in favor of step 86, where the instruction is written to File.asm (temporary) 46. Step 88 checks to see if all instructions have been processed. If not, the preprocessor procedure will return to step 82 to scan the next instruction in the File.asm 40. If not, step 90 returns to the control script 44 at A.

If, in step 84, it is determined that the instruction is a new instruction, step 84 is left in favor of step 92, where the instruction is checked to ensure it is a valid “new” instruction. If the validity check fails, an error is generated, and the preprocessing stops. Assuming the instruction is found valid, the preprocessor 42 will proceed to step 94, where the instruction is converted to its operation code (op code) equivalent. In essence, step 94 involves parsing the instruction to build the new operation code from symbolic constant definitions of operation code fragments and register encodings to form the binary equivalent of the instruction. That binary equivalent, once constructed, is then converted to an ASCII hexadecimal value and, that, in step 96, written to the temporary source code file 46 as data, using a data insertion directive (e.g., “.DATA”). Step 96 is followed by step 88 to determine if there are still instructions in the original source code file 40 that have not been written, either directly or as inserted data, to the temporary source code file 46. If so, steps 84, 86, 88, 92, 94, and 96 are continued.

Once all instructions of the original source code file have been processed, the preprocessor will exit at A (step 90), returning to the control script 44 at step 72 where the two source files 40 and 46 are renamed. The original source file (File.asm) is saved by renaming it as File.sav, for example. (Alternately, it could be saved to a new directory, or renamed and saved to a new directory.) The temporary source file 46 (File.tmp) is given the name initially used for the original source code file 40: File.asm. Then, the control script 44 will move to step 73 to call the (old) assembler 48, recording with it the name of (temporary) File.asm 46. The assembler 48 will then process the temporary source code file 46, converting each of the old instructions 40a into their op code equivalents. When a data directive is encountered, the data, which is the op code equivalent of a new instruction 40b, is inserted in the object code file 50 as part of the instruction stream.

When the assembler has finished, the control script 44 will restore the original source code file in step 74, deleting the temporary file, and terminate with step 76. As is conventional, the file name of the source code file (now bearing its original name: File.asm) has been recorded in the object code, allowing the new ISS 56 user to view and debug new instructions in their human readable (mnemonic) form rather than as “.DATA” directives.

What is claimed is:

1. A method of converting a source code containing a plurality of instructions in a predetermined order, including new instructions, to object code for use by a processor, the method including the steps of:
copying plurality of instructions to a temporary file, the new instructions each being copied as data in the form of object code corresponding to such instruction;
applying the plurality of instructions of the temporary file to an assembler to produce object code corresponding to the old instructions and the data forming object code for the new instructions.

2. A method of assembling source code containing existing machine language instructions and new machine language instructions with an existing assembler to produce object code having machine language instructions corresponding to each the instructions of the existing instruction set and the new instructions, the method including the steps of:
copying each of the existing machine language instructions to a temporary file;
copying each new machine language instruction to the temporary file as a data directive having a form corresponding to object code corresponding to such new machine language instruction;
assembling the machine language instructions and the data directives to produce the object code.
